(19) United States
(12) Patent Application Publication
(10) Pub. No.: US 2024/0111285 A1
(43) Pub. Date: Apr. 4, 2024

(54) AUTONOMOUS VEHICLE DELIVERY SYSTEM

(71) Applicant: T-Mobile Innovations LLC, Overland Park, KS (US)

(72) Inventors: Stephen Matthew Jones, Allen, TX (US); Robert Corey Farmer, Plano, TX (US); George Marc Myers, II, Delafield, WI (US)

(21) Appl. No.: 17/956,213

(22) Filed: Sep. 29, 2022

(51) Int. Cl. G05D 1/00; G06Q 10/08; H04W 4/029

(52) U.S. Cl. CPC G05D 1/0088; G06Q 10/083; H04W 4/029; G05D 2201/0213

(57) ABSTRACT

Systems, methods, and computer-readable media are provided for using and dispatching an autonomous delivery. A wireless communications network may receive a request to delivery one or more items to a site and also determine that the autonomous delivery vehicle is the closest in location to the site from a plurality of autonomous vehicles. Additionally, the wireless communications network may determine that the autonomous delivery vehicle has stored thereon, the one or more requested items. The autonomous delivery vehicle may then receive by way of a wireless communication network, the request to delivery one or more items to an infrastructure site. The autonomous delivery vehicle then uses the location of the site to autonomously deliver the one or more items.

### SUMMARY

A high-level overview of various aspects of the present disclosure is provided here to introduce a selection of concepts further described below in the detailed description. This summary is neither intended to identify key features or essential features of the claimed subject matter, nor intended to be used as an aid in isolation to determine the scope of the claimed subject matter.

In brief and at a high level, the present disclosure describes, among other things, systems, methods, and computer-readable media that employ a unique method of providing a mechanism for dispatching a delivery vehicle from an origin location to a work site by way of an automatically dispatched delivery vehicle. This is all done by way of a wireless network which facilitates delivery of the requested parts to the work site.

### BRIEF DESCRIPTION OF THE DRAWINGS

Illustrative embodiments of the present disclosure are described in detail below with reference to the attached drawing, wherein:

FIG. 1 depicts an exemplary network environment, in accordance with an aspect of the present disclosure;

FIG. 2 depicts an exemplary network environment, in accordance with an aspect of the present disclosure;

FIG. 3 depicts an exemplary wireless communications environment, in accordance with an aspect of the disclosure;

FIG. 4 depicts a flowchart of an exemplary method, in accordance with an aspect of the present disclosure; and

FIG. 5 depicts an exemplary computing environment suitable for use in implementations of aspects of the present disclosure.

### DETAILED DESCRIPTION

The subject matter of selective embodiments of the present disclosure are described with specificity herein to meet statutory requirements. The detailed description is not intended to define what is regarded as the invention nor intended to limit the scope of the claimed subject matter. The claimed subject matter might be embodied in other ways to include different steps or combinations of steps similar to those described herein, in conjunction with other present or future technologies. Terms recited herein should not be interpreted to imply any particular order among or between various steps described herein unless and except when an order of individual steps is explicitly described.

Throughout the detailed description of the present disclosure, several acronyms and shorthand notations are used to aid the understanding of certain concepts pertaining to an associated system and services. These acronyms and shorthand notations are solely intended for the purpose of providing an easy methodology of communicating the ideas expressed herein and are in no way meant to limit the scope of the present disclosure. The following is a list of these acronyms:

| | |
|---|---|
| AWS | Advanced Wireless Services |
| BRS | Broadband Radio Service |
| BTS | Base Transceiver Station |
| CDMA | Code Division Multiple Access |
| EBS | Educational Broadband Services |
| eNodeB | Evolved Node B |
| EVDO | Evolution-Data Optimized |
| gNodeB | Next Generation Node B |
| GPS | Global Positioning System |
| GSM | Global System for Mobile Communications |
| HRPD | High Rate Packet Data |
| eHRPD | Enhanced High Rate Packet Data |
| LTE | Long Term Evolution |
| LTE-A | Long Term Evolution Advanced |
| PCS | Broadband Personal Communications Service |
| RNC | Radio Network Controller |
| SyncE | Synchronous Ethernet |
| TDM | Time-Division Multiplexing |
| VOIP | Voice Over Internet Protocol |
| WAN | Wide Area Network |
| WCS | Wireless Communications Service |
| WiMAX | Worldwide Interoperability for Microwave Access |

Further, various technical terms are used throughout the detailed description. Definitions of such terms can be found in, for example, Newton's Telecom Dictionary by H. Newton, 32nd Edition (2022). These definitions are intended to provide a clear understanding of the ideas disclosed herein but are not intended to limit the scope of the present disclosure. The definitions and the terms should be interpreted broadly and liberally to an extent allowed by the meaning of the words offered in the above-cited reference.

Embodiments of the technology described herein may be implemented as, among other things, a method, a system, or a computer-program product. Accordingly, the embodiments may include a hardware embodiment, or an embodiment combining a software and a hardware. In one embodiment, the present disclosure includes the computer-program product that includes computer-useable instructions embodied on one or more computer-readable media.

The computer-readable media includes volatile and/or nonvolatile media, removable and non-removable media, and contemplates media readable by a database, a switch, and various other network devices. Network switches, routers, and related components are conventional in nature, as are the means of communicating with the same. By way of non-limiting example, the computer-readable media includes computer storage media and/or communications media. The computer storage media, or machine-readable media, includes media implemented in any method or technology for storing information. Examples of stored information includes computer-useable instructions, data structures, program modules, and other data representations. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile discs (DVDs), holographic media or other optical disc storage, magnetic cassettes, magnetic tape, magnetic disc storage, and/or other magnetic storage devices. These memory components may store data momentarily, temporarily, or permanently. The computer storage media does not encompass a transitory signal in embodiments of the present disclosure. The computer storage media does not comprise a propagated data signal.

The communications media typically stores computer-useable instructions, including data structures and program modules, in form of a modulated data signal. The term “modulated data signal” refers to a propagated signal that has one or more of its characteristics set or changed to encode information associated therewith. The communications media includes any information-delivery media. By way of non-limiting example, the communications media includes wired media, such as a wired network or a direct-wired connection; and wireless media, such as acoustic, infrared, radio, microwave, spread-spectrum, and other wireless media technologies. Combinations of the above are included within the scope of the computer-readable media.

It should be understood that any user equipment (UE) discussed herein is in general form of equipment and machines, such as, but not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, or any other smart device that, at least in part, is operated based on micro-service data received via a network. That said, in some embodiments, the UE may also include handheld personal computing devices, such as cellular phones, tablets, and similar consumer equipment, or stationary desktop computing devices, workstations, servers and/or network infrastructure equipment. As such, the UE may include both mobile UE and stationary UE configured to request micro-service data from the network.

At a high level, systems, methods, and the computer-readable media described herein provides for the use and facilitation of delivery of one or more items using a mobile autonomous delivery vehicle (alternatively referred to as “delivery vehicle” and “mobile drone delivery device” in the present disclosure). Currently, there is nothing which provides for an autonomous delivery vehicle to be dispatched from a location. Especially, wherein the autonomous delivery vehicle is stocked with spare parts for repairing or upgrading infrastructure. In an instance where a work crew finds themselves in need of one or more spare parts, a member of the work crew generally needs to drive to the location where the spare parts are housed and then drive back with the part. This may add several hours of time to a time-sensitive repair or upgrade when that piece of infrastructure may be offline during the repair. For example, there exists several remote locations which houses wireless network infrastructure that may be several hours drive to the nearest location to find the spare parts. If the spare part is needed close to the end of the day or overnight, it may be the next day, or worse, before the spare part can be located and obtained. Additionally, spare parts are generally housed in warehouses far from where repairs and/or upgrades occur.

According to a first aspect of the present disclosure, a method for dispatching an autonomous delivery vehicle is provided. The method includes receiving, from a first location, by way of a wireless communications network, a set of coordinates corresponding to the first location and a request to deliver one or more parts to the first location. The method further includes determining, by way of the wireless communications network, one or more autonomous delivery vehicles that have stored within each one of the one or more autonomous delivery vehicles, the one or more parts. The method further includes determining, by way of the wireless communications network, a first autonomous delivery vehicle of the one or more autonomous delivery vehicles, where the first autonomous delivery vehicle is a closest delivery vehicle relative to the first location. The method further includes communicating, to the first autonomous delivery vehicle by way of the wireless communications network, instructions to deliver the one or more parts requested to the first location. The method also includes receiving, by way of the wireless communications network, an indication that the first delivery vehicle has delivered the one or more parts to the first location.

According to a second aspect of the present disclosure, computer-readable media is provided. The computer-readable media includes computer-executable instructions embodied thereon that, when executed, perform a method for dispatching a delivery vehicle. The method includes receiving, from a first location, by way of a wireless communications network, a set of coordinates corresponding to the first location and a request to deliver one or more parts to the first location. The method further includes determining, by way of the wireless communications network, one or more delivery vehicles that have stored within each one of the one or more delivery vehicles, the one or more parts. The method includes determining, by way of the wireless communications network, a first delivery vehicle of the one or more delivery vehicles, where the first delivery vehicle is a closest delivery vehicle relative to the first location. The method further includes communicating, to the first delivery vehicle by way of the wireless communications network, instructions to deliver the one or more parts requested to the first location. The method also includes receiving, by way of the wireless communications network, an indication that the first delivery vehicle has delivered the one or more parts to the first location.

According to a third aspect of the present disclosure, a system is provided. The system includes one or more processors configured to perform a computer implemented method. The computer implemented method includes dispatching a delivery vehicle. The method includes receiving, from a first location, by way of a wireless communications network, a set of coordinates corresponding to the first location and a request to deliver one or more parts to the first location. The method further includes determining, by way of the wireless communications network, one or more delivery vehicles that have stored within each one of the one or more delivery vehicles, the one or more parts. The method includes determining, by way of the wireless communications network, a first delivery vehicle of the one or more delivery vehicles, where the first delivery vehicle is a closest delivery vehicle relative to the first location. The method further includes communicating, to the first delivery vehicle by way of the wireless communications network, instructions to deliver the one or more parts requested to the first location. The method also includes receiving, by way of the wireless communications network, an indication that the first delivery vehicle has delivered the one or more parts to the first location.

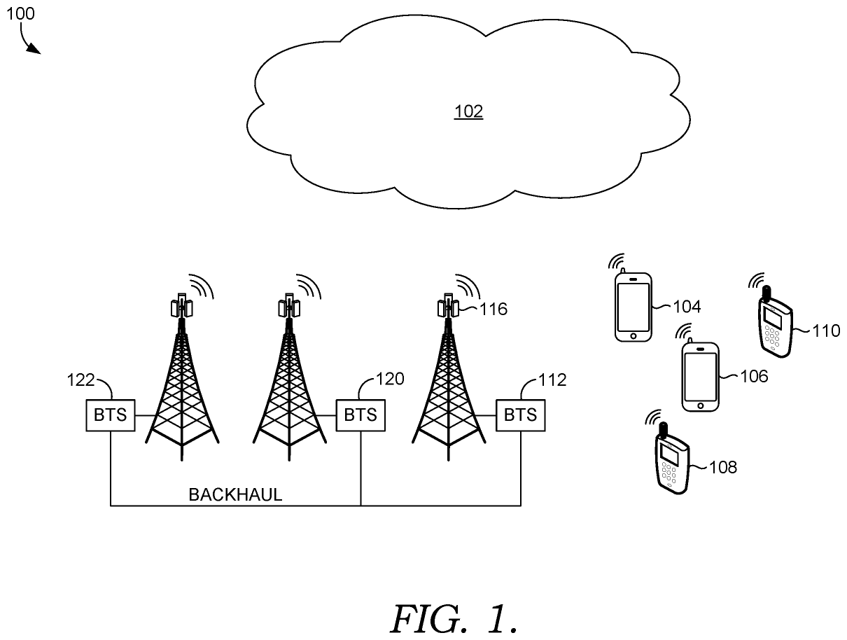

Referring to FIG. 1, an example of a network environment 100 suitable for use in implementing embodiments of the present disclosure is illustrated. The network environment 100 is illustrated as an example of a suitable network environment and is not intended to suggest any limitation to the scope of use or functionality of the present disclosure. Neither should the network environment 100 be interpreted as having any dependency or requirement relating to any one or combination of components illustrated in FIG. 1.

The network environment 100 includes a network 102 that provides service to current user equipment (UE) 104, Internet of Things (IoT) device 106, and one or more legacy UE 108 and 110. The network environment 100 may also include a network 102 that provides service to a receiver operating within an autonomous delivery vehicle. The network 102 may be accessible through a base transceiver station 112 that is connected to a backhaul server (not shown). The base transceiver station 112 and/or a computing device (for example, a local device or a remote device) associated with the base transceiver station 112 may manage or otherwise control operation of components of a cell site, including an antenna array 116. The base transceiver station 112 and/or the computing device associated with the base transceiver station 112 may include one or more processors and computer-readable storage media having computer-executable instructions or computer instruction modules embodied thereon for execution by the one or more processors.

Any of the UEs 104, 106, 108, and 110 discussed above may be implemented or used as part of the system herein described. The UEs may be implemented as part of an autonomous delivery vehicle directly connected to the network 102. For example, the network 102 may wirelessly or directly connect to a UE associated with an autonomous delivery vehicle. Such UE may be able to receive instructions from the network 102 to deliver a parcel or proceed to travel to a particular destination. The network 102 may provide the UE a set of directions/instructions for the autonomous delivery vehicle based on the network 102 querying a database. The database may be used to store an inventory in order to determine that an autonomous delivery vehicle contains a desired/requested spare part or a piece of equipment associated with that autonomous delivery vehicle.

In another aspect, the UEs 104, 106, 108, and 110 discussed above may be implemented or used as part of a destination/requesting system described herein. For example, the UE associated with a delivery location, or a destination location, may comprise one or more sensors or systems used to determine a location of the delivery location. These UEs associated with the delivery location may also be used to communicate with the network 102, a request for a part or a piece of equipment to be delivered by way of an autonomous delivery vehicle either autonomously or manually.

The antenna array 116 may radiate in a particular direction and, thus, may correspond to a particular sector of the cell site. In some embodiments, the antenna array 116 may have a plurality of antenna elements. In one embodiment, the antenna array 116 is configured to have a plurality of elements that in number, arrangement, and/or density, are configured for massive Multiple-in Multiple-out (mMIMO) configuration. In one embodiment, the base transceiver station 112 may include a radio and/or a controller, such as a massive Multiple-Input Multiple-Output (mMIMO) Unit for controlling a mMIMO configured antenna array, such as the antenna array 116 having the plurality of antenna elements. The base transceiver station 112 may use the controller to monitor one or more of throughput, signal quality metrics (for example, signal-to-interference-plus-noise ratio (SINR)), number of unique users/subscribers, number of unique UE(s), and/or remote location filings (RLFs) that occur at the base transceiver station 112, all of which may be monitored dynamically and/or stored in a data store. The antenna array 116 may also be configured to operate under a lower order number of antenna elements than an antenna array configured to operate under the mMIMO configuration. Such a lower order configuration may be a legacy system, such as an eight branch transmit and eight branch receive (8T8R) antenna structure.

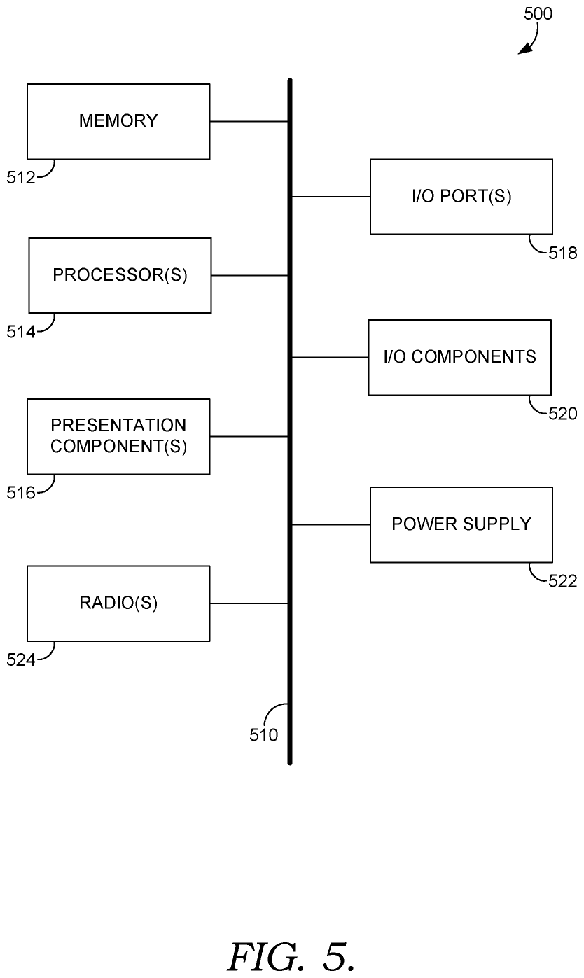

The base transceiver station 112 may use a radio (such as the radio 524 shown in FIG. 5) that is connected to the antenna array 116 by a physical radio-frequency (RF) path, where the radio is used to cause the antenna array 116 to transmit radio-frequency signals using the plurality of antenna elements. The plurality of antenna elements in the antenna array 116 may include portions of antenna elements (not shown). In some embodiments, the plurality of antenna elements of the antenna array 116 may be partitioned such that a first portion of antenna elements may be associated with, dedicated to, correspond to, and/or be configured to operate using a first access technology, and a second portion of antenna elements may be associated with, dedicated to, correspond to, and/or be configured to operate using a second access technology. In one embodiment, the plurality of antenna elements may be partitioned into unequal groups or, alternatively, “split” into equal halves, wherein each group or half operates to provide a coverage area for a distinct access technology when the antenna array 116 operates in a dual technology mode.

In some embodiments, the antenna array 116 is partitioned such that the first portion of antenna elements is associated with the first access technology and the second portion of antenna elements is associated with the second access technology. In some embodiments, when the antenna array 116 is operating in the dual technology mode, each portion of the plurality of antenna elements may operate using only one distinct protocol and/or an access technology relative to the other portions in the antenna array 116. In one example, the first portion of antenna elements may operate using 5G wireless access technology and the second portion of antenna elements may operate using 4G wireless access technology. Additionally, it will be understood that the terms “first” and “second” are used herein for the purpose of clarity in distinguishing portions of antenna elements from one another, but the terms are not used herein to limit the sequence, relevance, number of portions, technological functions, and/or operations of each portion unless specifically and explicitly stated.

As such, the base transceiver station 112 may provide the current UE 104, the IoT device 106 and the legacy UE 108 and 110 with access to the network 102. In some embodiments, the first portion of antenna elements may communicate with the current UE 104 and the IoT device 106 using the 5G wireless access technology, and the second portion of the antenna elements may communicate with the legacy UE 108 and 110 using the 4G wireless access technology. When operating in the dual technology mode, the antenna array 116 may concurrently connect to and communicate with the current UE 104, the IoT device 106, and the legacy UE 108 and 110 using, respectively, at least two distinct access technologies. Additionally, the first portion of the antenna elements may communicate with the IoT device 106 using 4G wireless access technology or any other wireless technology.

Accordingly, in one example, when the antenna array 116 is operating in the dual technology mode, the base transceiver station 112 concurrently acts an eNodeB (or “eNB”) and gNodeB (or “gNB”). As such, the base transceiver station 112 may provide service to one or more access technologies to both the current UE 104, the IoT device 106, and the legacy UE 108, 110. In addition to communicating with the current UE 104, the IoT device 106, and the legacy UE 108 and 110, the base transceiver station 112 may also communicate with one or more neighboring base transceiver stations. In some embodiments, the base transceiver station 112 may communicate with one neighboring base transceiver station 120 using the first access technology and may communicate with another neighboring base transceiver station 122 using the second access technology. For example, since the base transceiver station 112 may operate concurrently as the eNodeB and the gNodeB using the antenna array 116 that is partitioned and operating in the dual technology mode, the base transceiver station 112 may communicate with other base transceiver stations, such as the neighboring base transceiver stations 120 and 122. For example, the base transceiver station 112 communication may include legacy base transceiver stations that cannot use current access technologies (for example 5G) or current base transceiver stations that lack backward compatibility with prior access technologies (for example 4G). In some embodiments, the base transceiver station 112 may bi-directionally exchange information with the neighboring base transceiver stations 120 and 122 through an X2 interface or an X2 link. Information regarding signal quality, RF conditions, one or more RLFs, and SINR levels at each of the neighboring base transceiver stations 120 and 122, and/or as reported from the current UE 104 or the legacy UE 108, 110 to the neighboring base transceiver stations 120 and 122, may be communicated to the base transceiver station 112 via the X2 link. Additionally, or alternatively, information regarding the signal quality, the RLFs, and the SINR levels at each of the neighboring base transceiver stations 120 and 122 may be communicated to the base transceiver station 112 over a backhaul.

As mentioned, the base transceiver station 112 may include the radio and/or the controller, such as a memory management unit (MMU) that enables the base transceiver station 112 to adjust or modify the operations and transmissions of the plurality of antenna elements in the antenna array 116. In some embodiments, operations, configurations, and/or settings of each antenna element may be individually controlled and adjusted by the base transceiver station 112 using the controller. In some embodiments, the operations, configurations, and/or settings of the first portion of antenna elements may be controlled and adjusted as a group by the base transceiver station 112 using the controller, such as the MMU, independent of the second portion of antenna elements. In a similar fashion, the operations, the configurations, and/or the settings of the second portion of antenna elements may be controlled and adjusted as a group by the base transceiver station 112 using the controller, independent of the first portion of antenna elements. Accordingly, the base transceiver station 112 may use the controller to independently adjust different groups or portions of the antenna elements within one antenna array, such as the antenna array 116.

In some embodiments, the operations, the configurations, and/or the settings of each individual antenna element may be adjusted and customized. For example, the base transceiver station 112 instructs a portion of the antenna elements to transmit one or more synchronization signals using a periodicity. In another example, the portion of the antenna elements may transmit a plurality of synchronization signals using the periodicity, as instructed by the base transceiver station 112. In some embodiments, the synchronization signals may be specific to and/or configured for the first access technology.

Accordingly, the base transceiver station 112 may use the controller to independently adjust different individual antenna elements, any number of groupings and/or subset(s) of each portion of the antenna elements, and/or portions of the antenna elements within one antenna array, such as the antenna array 116. In some embodiments, the base transceiver station 112 may use the controller to measure and monitor one or more of throughput, signal quality metrics (for example, SINR), number of unique users/subscribers, number of unique UE, and/or RLFs.

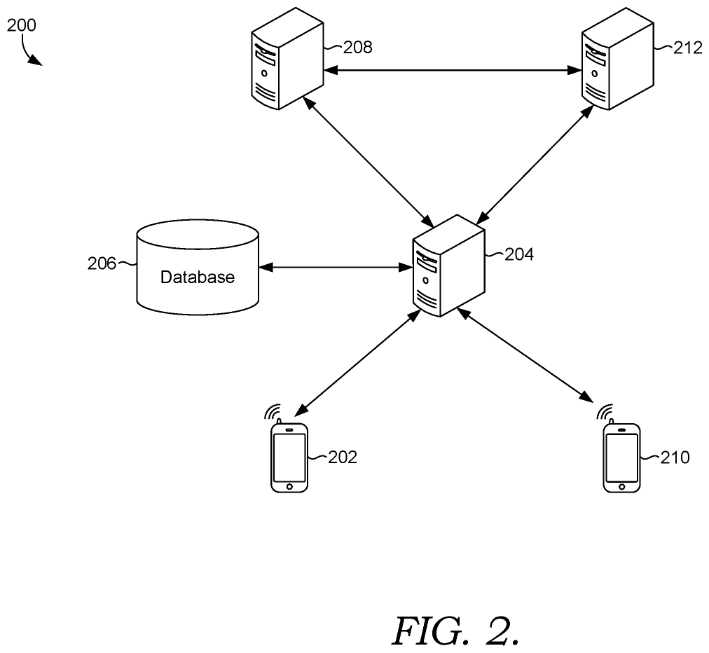

Referring to FIG. 2, an exemplary network environment 200 is illustrated in which implementations of the present disclosure may be employed. The network environment 200 is one example of a suitable network environment and is not intended to suggest any limitation as to the scope of use or functionality of the present disclosure. Neither should the network environment 200 be interpreted as having any dependency or requirement relating to any one or combination of components illustrated.

The network environment 200 represents a high level and simplified view of relevant portions of a modern wireless telecommunication network. At a high level, the network environment 200 may generally include one or more UEs, such as a first UE 202 and a second UE 210, a network 204, a database 206, one or more user device accounts, such as a first UE account 208 and a second UE account 212, though in some implementations it may not be necessary for certain features to be present. The network environment 200 is generally configured for wirelessly connecting the first UE 202 with other UEs and with other telecommunication networks, such as a publicly-switched telecommunication network (PSTN), or data or services that may be accessible on one or more application servers or other functions, nodes, or servers not illustrated in FIG. 2, so as to not obscure the focus of the present disclosure. As illustrated generally, the first UE 202 may be implemented as, for example, a tablet, a phone, or a wearable device, or any other device discussed with respect to FIG. 1, such as a UE associated with an autonomous delivery vehicle or delivery vehicle.

The first UE 202 is generally configured to transmit and receive one or more signals to and from a base transceiver station (such as the base transceiver station 112 in FIG. 1) associated with the network 204. Communication protocols associated with the network 204 are configured to receive one or more signals from the first UE 202, and the one or more signals may be implemented as uplink signals. In response to receiving certain requests from the first UE 202, the communication protocol may communicate with the network 204. For example, in order for the first UE 202 to connect to a desired network service (for example, PSTN call, voice over LTE (VoLTE) call, voice over new radio (VoNR), data, or the like), the first UE 202 may communicate an attach request to the communication protocol, which, in response, may communicate a registration request to the network 204. The communication protocol may take the form of a home network (for example, a protocol belonging to or affiliated with a carrier associated with the first UE 202) or a visiting/roaming network (for example, a protocol belonging to or operated by an entity other than the carrier associated with the first UE 202, but which, in certain conditions, may provide extended wireless access to the first UE 202 beyond a reach of the home network).

In one aspect, the first UE 202 may be a mobile UE device associated with an individual working on a wireless base station or a piece of infrastructure associated with a wireless communications network. In another aspect, the individual may be associated with a repair crew for an infrastructure building or a piece of equipment that is being constructed or repaired. For example, the first UE 202 may correspond to a mobile device of a worker, or a technician, sent to repair a wireless network facility which may house a piece of wireless infrastructure. Such infrastructure building may have been damaged by normal wear and tear, or by a natural disaster, or by any other means, and may necessitate a repair. The infrastructure building may also be under construction as a new piece of infrastructure. The worker or the technician may identify a particular part or a piece of equipment needed/desired to complete the repair or build and may determine that the part or the piece of equipment is not present at the site that requires the desired repair and/or build. Using the first UE 202, the worker or the technician may send a request for the part or the piece of equipment by way of the network 204.

The network 204 may be a part of a telecommunication network that connects subscribers to their service provider. In some aspects, the service provider may be a telecommunications service provider, an internet service provider, or any other similar service provider that provides at least one of voice telecommunications and/or data services to the first UE 202 and any other UEs. For example, the network 204 may be associated with a telecommunications provider that provides services (for example, LTE) to the first UE 202. Additionally, or alternatively, the network 204 may provide voice, SMS, and/or data services to user devices or corresponding users that are registered or subscribed to utilize the services provided by the telecommunications provider. The network 204 may include any communication network providing voice, SMS, and/or data service(s), using any one or more communication protocols, such as a 1×circuit voice, a 3G network (for example, CDMA, CDMA2000, WCDMA, GSM, UMTS), a 4G network (WiMAX, LTE, HSDPA), or a 5G network. The network 204 may also be, in whole or in part, or have characteristics of, a self-optimizing network.

The network 204 includes one or more systems that are enabled for routing information and/or enabling communication between the first UE 202 and the second UE 210. Additionally, the network 204 includes one or more systems that are enabled for communication between the network 204, the first UE 202, and the first UE account 208. In one example, the first UE account 208 is directly associated with the network 204. For example, the network 204 enables the first UE 202 to communicate by way of the network 204 because the first UE 202 is subscribed to the network 204 through the first UE account 208. The network 204 is enabled to communicate with the first UE account 208 through one or more systems and/or the database 206. The first UE account 208 enables the first UE 202 to communicate through the network 204.

The database 206 may be accessed or queried by the network 204. Such database 206 may house a store of an inventory of parts and pieces of equipment that is housed within a geographic area of the first UE 202. For example, the database 206 may have an inventory of all parts and pieces of equipment located within a 20 mile radius of a work or build site. The inventory may be a dynamic list of all parts and pieces of equipment that is within a desired radius of a central location or a within a geographic location. Such pieces of equipment may be tracked or inventoried using a barcode or other tracking method to input and track an item. Such items may be scanned at a location and input into the inventory identifying the geographic location of the item and the specifications of the item. The item may also be indicated as located and stored on a vehicle, such as the autonomous delivery vehicle. The database 206 may house all information in a standard format allowing the network 204 to query such information and find items located within a desired radius of a particular location. Such queries may also indicate that the item needs to be located on the autonomous delivery vehicle and be able to be delivered within a particular time-frame.

In one aspect, the network 204 may receive a request from the first UE 202 for an item. The network 204 may then query the inventory held within database 206 to identify the locations of the item within the geographic area associated with the inventory. For example, the first UE 202 may submit a request for an item, wherein the first UE 202 is located in a large geographic location. Upon receiving the request, the network 204 may query the database 206 within an inventory list for the large geographic location for all of the parts located within that large geographic location. The database 206 may contain more than one items within the inventor list of the large geographic location. A processor associated with the network 204 may then identify the item that fits a criteria of the request that is geographically closest to the first UE 202 or a location of a requested delivery. The processor(s) associated with the network 204 may also identify the autonomous delivery vehicle that houses or stores the item such that the request to deliver the item may be sent to that autonomous delivery vehicle. As such, the network 204 may determine that an available item that is located closest to the first UE 202 is stored on an autonomous delivery vehicle associated with the second UE 210 and the request may then be sent by way of the network 204 to the second UE 210 with instructions for the item to be delivered by way of the autonomous delivery vehicle associated with the second UE 210.

In one aspect, the second UE 210 may be associated with an autonomous delivery vehicle that may include various computer components, processors, and/or memories that facilitate various operations thereof, and may also include communication components that facilitate communication and coordination of the second UE 210 and the network 204. An exemplary autonomous delivery vehicle may further include a propulsion system that allows the autonomous delivery vehicle to move to different locations. Such movement may be guided autonomously or with some degree of human input. In one example, the propulsion system includes one or more electric motors or one or more gas engines. It is contemplated that many other configurations of a conventional vehicle may be used in different embodiments to guide or track the autonomous delivery vehicle from an origin location to a desired delivery location. The origin location may be associated with a staging location for a plurality of autonomous delivery vehicles. Such staging location may be in response to a demand for repairs or new builds forecasted by contraction forecasting models or incidence related models, such as weather or disaster forecasting. Additionally, the staging location may be in response to a natural disaster, and the plurality of autonomous delivery vehicles may be staged in a central location so as to alleviate long wait times for parts required in repairing the infrastructure. Each of the plurality of autonomous delivery vehicles may have stored therein, a set of items or a piece of equipment that may be required during construction or repair of the infrastructure. Additionally, the origin location may have located thereon, one or more wireless charging stations for the autonomous delivery vehicles. The second UE 210 may also be any other form of autonomous or semi-autonomous vehicle which may move and or be operated to deliver a package to a destination, such as the location of the first UE 202 or a site of the desired repair or delivery.

The first UE 202 may include portions which are able to determine a geo-location thereof. Such portions of the first UE 202 may include a GPS locator, or any other geo-location device located on or near the first UE 202. The first UE 202 may also include a wireless communication capabilities or even leverage a wireless communication device, such as a mobile phone or a tablet.

The first UE 202 may also include a location determiner that uses GPS sensors on the first UE 202, or another method of location determination, to determine the location of the first UE 202 or a delivery location. For example, based on GPS data, or other location determination information, received from the first UE 202, the location determiner will determine an address of the location of the first UE 202 and a general location within the delivery location that the second UE 210 may generally approach prior to determining an exact location of the first UE 202 with respect to the second UE 210 using relative location calculation methods.

In yet another aspect, the second UE 210 is operated using human intervention, such as a remote control or other steering device. In a further aspect, the second UE 210 is operated autonomously. The autonomous movement of the second UE 210 may be such that the first UE account 208 may communicate that the second UE 210 must move from a first location or a current location to a second location or a delivery location. The second UE 210 may then determine the current location thereof and autonomously move from the current location to the second location or the delivery location.

Relevant to the present disclosure, the first UE 202 may first initiate a request to establish a communication between the first UE 202 and the network 204. This communication may be a wireless communication using communication protocols, such as a first wireless communication protocol. The communication may also be a hardwired communication with the network 204 through a direct communication line between the first UE 202 and the network 204. In other aspects, the network 204 may initiate a request with the second UE 210 to initiate a wireless communication. For example, the network 204 may receive a request to deliver an item using the second UE 210 which may be an autonomous delivery vehicle with capacity to deliver packages and items. Once the network 204 receives such request, the network 204 may initiate a request to the second UE 210 to establish a wireless communication, and then send the request, by way of the wireless communication, to the second UE 210 to deliver the package.

In one aspect, the network 204 may receive a request to deliver one or more items using the second UE 210 to an address associated with the first UE 202. Subsequently, the first UE 202 may send the location of the first UE 202 to the network 204. Such general location may be an address, a set of GPS coordinates, a geo-fence, or any other location information. Once the network 204 receives the location of the first UE 202, the network 204 may determine that the closest available vehicle (such as the delivery vehicle or the autonomous delivery vehicle) with each of the one or more items stored thereon is the vehicle associated with the second UE 210. Subsequently, the network 204 may send the location of the first UE 202, via a wireless communications network, to the second UE 210, and request the second UE 210 to deliver the one or more items stored on the vehicle associated therewith. Such items may be attached to a drone, inside the drone, or the drone itself. Additionally, the items may be stored in a storage compartment in the autonomous delivery vehicle. Additionally, delivery information may include a package identification, a sender information, a recipient information, and any other information required so that the items requested may be delivered from the location of the second UE 210 to the location of the first UE 202.

Upon receiving the request to deliver the one or more items, the second UE 210 may then determine a route from its current location to the location of the first UE 202. Upon determining a route, the second UE 210 may initiate a communication with the autonomous delivery vehicle and instruct it to proceed from its current location to the location of the first UE 202. Upon arriving at the location of the first UE 202, the second UE 210 may communicate a notification that it has arrived at the delivery location. Additionally, the first UE 202 may also send and/or receive a notification of the arrival of the second UE 210 or the autonomous delivery vehicle.

In an additional aspect, the network 204 may track the location of the second UE 210 by means of the second UE 210 and a location determiner located on the second UE 210. The location may be communicated from the second UE 210 to the first UE 202 by means of the network 204. The first UE 202 may receive regular updates of the location or status of the second UE 210. For example, the second UE 210 may send a notification upon it receiving the request to deliver the one or more items. A notification may also be communicated upon the second UE 210 leaving the origin location. Notifications may also be sent from the second UE 210 to the first UE 202 during a travel from the origin location to the location of the first UE 202.

Once the second UE 210 arrives at the location of the first UE 202, a user or a worker may remove the one or more items by some secure method of accessing the autonomous delivery vehicle. The user of the first UE 202 may be required to input some security code or key such that the second UE 210 may allow access to the one or more items. Once an identity of the user is authenticated, the user may retrieve the one or more items. The items may also be removed from the inventory list on the database 206 by the first UE 202 via scanning a bar code or other identifier associated with the one or more items. As the first UE 202 or the second UE 210 scans the items, it is removed from the inventory list.

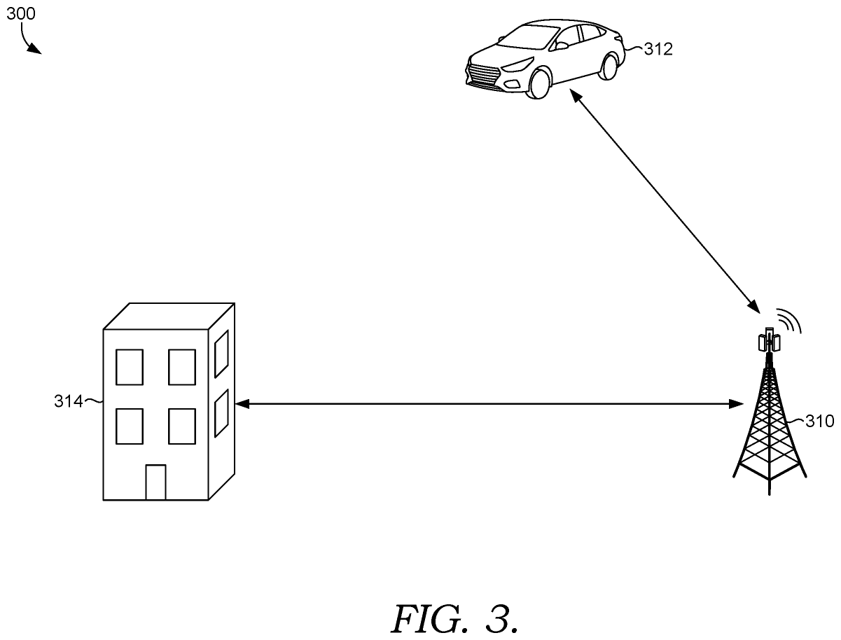

Turning now to FIG. 3, an exemplary wireless communications environment 300 is shown according to one aspect of the present disclosure. The wireless communications environment 300 may include one or more wireless communications networks, wireless base station or cell sites 310, which may correspond to the network 204, the network 102, and the base transceiver station 112 as described with respect to FIG. 1 and FIG. 2, and may exist with one or more components discussed in greater detail herein and is not meant to exhaustively show every interaction that would be necessary to practice the present disclosure, so as to not obscure the inventive concept, but is instead meant to illustrate one or more potential interactions between the components. The wireless communications environment 300 may include a delivery vehicle 312 which may correspond to the second UE 210 as described with respect to FIG. 2 and may exist with one or more components discussed in greater detail herein and is not meant to exhaustively show every interaction that would be necessary to practice the present disclosure, so as to not obscure the inventive concept but is instead meant to illustrate one or more potential interactions between the components. Additionally, the wireless communications environment 300 may include a first location 314 which may correspond to the location of the first UE 202 as described with respect to FIG. 2, and may exist with one or more components discussed in greater detail herein and is not meant to exhaustively show every interaction that would be necessary to practice the present disclosure, so as to not obscure the inventive concept, but is instead meant to illustrate one or more potential interactions between the components.

In some embodiments, the first location 314 may be associated with the first UE 202 which may initiate a wireless communication or a wired communication with the cell site 310. The first UE 202 associated with the first location 314 may require a user to actively select or press a button which initiates the communication or scans a bar code, a QR code, or other activation method to initiate the communication. In other aspects, the user may have an application installed on the first UE 202 which may communicate via NFC, Bluetooth, wired, or any other wireless communication methods. Such an application may be able to request the first UE 202 associated with the first location 314 to initiate communications with the wireless communications network 310. Additionally, such an application may be used to initiate a request to deliver the items as described above.

In some embodiments, the delivery vehicle 312 may be autonomous. In embodiments where the delivery vehicle 312 is autonomously controlled or operated, the autonomous delivery vehicle may have at least one sensor that is used to monitor the environment around the delivery vehicle 312 and/or guide the delivery vehicle 312 to avoid hazards. Multiple sensors may also be employed within the autonomous delivery vehicle to monitor the environment around the vehicle or the environment around an object being shifted. For example, using the delivery vehicle 312 and the sensor(s) thereof, a package may be shifted and/or picked up and attached with greater knowledge of locations of hazards in the environment (for example, obstacles, vehicles, etc.). Such monitored pick-up of the package may allow for objects to be picked-up with greater efficiency, and with less encountering of hazards. Additionally, the delivery vehicle 312 may be equipped with a package handling device, such as a tether or claw system, so as to pick up the package and store the package during transport. In one aspect, the package may be placed within the package handling device within the delivery vehicle 312. In another aspect, the delivery vehicle 312 may be able to pick-up and store the package to be delivered. Additionally, the package to be delivered may be the delivery vehicle 312 itself.

The delivery vehicle 312, may operate using an internal power source that must be replenished periodically. It is envisioned in some embodiments that the delivery vehicle 312 may operate as an autonomous automobile, autonomous drone (such as a mobile drone delivery device), or other autonomous vehicle capable of transporting one or more items from a staging location to the first location 314 or a construction location or an upgrade location. Additionally, the delivery vehicle 312 may be adapted to directly communicate with to the first location 314 by way of the wireless communications network 310 or without the wireless communications network 310. Such communication system may include, for example, a first communication component located on the first location 314 or the delivery vehicle 312, and a second communication component located at the first location 314 and the delivery vehicle 312. Such communication may be a wireless communication that is facilitated by one or more transmitting and receiving components, for example, antennas, and one or more radios operating in conjunction with the same.

The first location 314 and the delivery vehicle 312 may further be adapted to coordinate movement of the delivery vehicle 312 relative to the first location 314 as the first location 314 is in a position where an exact location is known to the delivery vehicle 312. For example, using the communication components described above and any sensor and computing mechanisms used for determination of relative location, the delivery vehicle 312 can control its position relative to the first location 314 in contemplated embodiments. For example, coordinated movement of the delivery vehicle 312 may allow the delivery vehicle 312 to determine a relative position, orientation, distance, and/or height relative to the first location 314, and deposit the one or more items in or on a location specified relative to the first location 314. Such maintaining of position of the delivery vehicle 312 and determining of the position of the delivery vehicle 312 may be facilitated by using feedback from one or more sensors on the first location 314 and/or the delivery vehicle 312. In this way, the delivery vehicle 312 and the first location 314 may effectively determine a relative position of the delivery vehicle 312 with respect to the first location 314. These sensors may be used to facilitate the determination of location using optical signals, auditory signals, or other signals used for calculation of the relative location.

In one embodiment, the first location 314 may be a location associated with the repair or building of a piece of network infrastructure. For example, the first location 314 may be a base station that is experiencing a required upgrade. As such, parts may be required to be delivered and such a request may come from a UE, such as the first UE 202. The request may then be delivered, by the wireless communications network 310, to the delivery vehicle 312 which houses at least the parts requested.

In an additional embodiment, the delivery vehicle 312 may be one of a plurality of autonomous delivery vehicles that are staged or positioned within a geographic region. For example, a forecasting model may predict that a particular region may experience a high volume of repair or new construction and, as such, the plurality of autonomous delivery vehicles may be stocked with a spares kit. Such spares kit may contain a plurality of parts that are associated with common repairs and/or new infrastructure builds. Additionally, the forecasting model may predict future construction needs based on upgrades, weather related instances, or any other instance that may require construction or repair of the infrastructure.

Additionally, the first location 314 may contain portions which allow the delivery vehicle 312 to deliver the package in a secure fashion. This may be a lock box, a secure tether, or other secure portion which permits the delivery vehicle 312 to place the package on the first location 314 and secure it such that the package may not be stolen. In an additional aspect, the first location 314 may have sensors, such as gyroscopes or telematics sensors, which may detect unauthorized movement at the first location 314. For example, if an unauthorized user picks up the package from the first location 314, a sensor may detect the movement and initiate a communication to the network 310 alerting the user that the first location 314 has been moved. The first location 314 may also include GPS tracking components which permit the first location 314 to communicate the general location of the first location 314 to the delivery vehicle 312 via the wireless communications network 310.

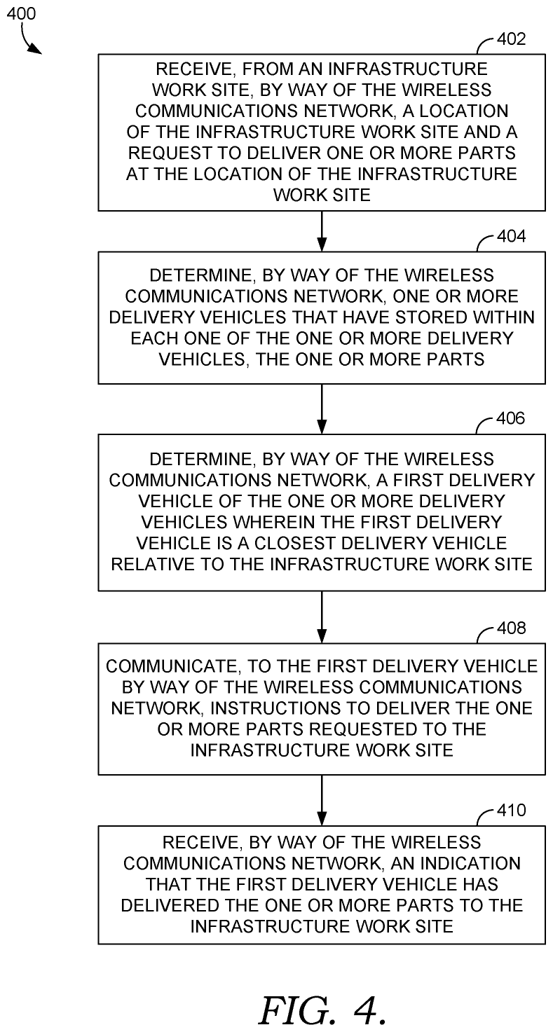

Referring now to FIG. 4, a flowchart of an exemplary method 400 is illustrated for providing a mobile delivery vehicle first location or a mobile delivery vehicle (such as the mobile drone delivery device) as described above, according to one aspect of the present disclosure. The method 400 is described in conjunction with FIG. 1 to FIG. 3. Initially, at block 402, the method 400 includes receiving, from an infrastructure work site (such as the first location 314), by way of the wireless communications network 310, a location (for example, a set of coordinates) of the infrastructure work site and a request to deliver one or more parts at the location of the infrastructure work site. At block 404, the method 400 includes determining, by way of the wireless communications network 310, one or more delivery vehicles (such as the delivery vehicle 312, also referred to as the autonomous delivery vehicles in the present disclosure) that have stored within each one of the one or more delivery vehicles, the one or more parts. At block 406, the method 400 includes determining, by way of the wireless communications network 310, a first delivery vehicle of the one or more delivery vehicles, where the first delivery vehicle is a closest delivery vehicle relative to the infrastructure work site. At block 408, the method 400 includes communicating, to the first delivery vehicle by way of the wireless communications network 310, instructions to deliver the one or more parts requested to the infrastructure work site. At block 410, the method 400 includes receiving, by way of the wireless communications network 310, an indication that the first delivery vehicle has delivered the one or more parts to the infrastructure work site.

Referring now to FIG. 5, an exemplary computing environment suitable for use in implementations of the present disclosure, is illustrated. In particular, the computer environment is shown and designated generally as a computing device 500. The computing device 500 is but one example of a suitable computing environment and is not intended to suggest any limitation as to the scope of use or functionality described in the present disclosure. Neither should the computing device 500 be interpreted as having any dependency or requirement relating to any one or combination of components illustrated in FIG. 5.

The implementations of the present disclosure may be described in the general context of a computer code or machine-useable instructions, including computer-executable instructions, such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, and the like. Implementations of the present disclosure may also be practiced in distributed computing environments where tasks are performed by remote-processing devices that are linked through a communications network.

With continued reference to FIG. 5, the computing device 500 includes a bus 510 that directly or indirectly couples the following devices: a memory 512, one or more processor(s) 514, one or more presentation component(s) 516, input/output (I/O) port(s) 518, I/O components 520, a power supply 522, and radio(s) 524. The bus 510 may include one or more busses (such as an address bus, a data bus, or a combination thereof). Although the devices in FIG. 5 are shown with lines for the sake of clarity, in reality, delineating various components is not so clear and, metaphorically, the lines would more accurately be grey and fuzzy. For example, one may consider a presentation component, such as a display device, to be one of the I/O components 520. Also, processors, such as the one or more processor(s) 514, may have the memory 512. The present disclosure herein recognizes that such is the nature of the art and reiterates that FIG. 5 is merely illustrative of an exemplary computing environment that may be used in connection with one or more implementations of the present disclosure. Distinction is not made between such categories as “a workstation,” “a server,” “a laptop,” “a handheld device,” etc., as all are contemplated within the scope of FIG. 5 and are referred to as “a computer” or “a computing device.”

The computing device 500 typically includes a variety of computer-readable media. The computer-readable media may be any available media that may be accessed by the computing device 500 and includes both volatile and nonvolatile media, removable and non-removable media. By way of a non-limiting example, the computer-readable media may include computer storage media and communication media. The computer storage media includes both volatile and nonvolatile, removable, and non-removable media implemented in any method or technology for storage of information, such as computer-readable instructions, data structures, program modules, or other data.

The memory 512 includes computer-storage media in the form of volatile and/or nonvolatile memory. The memory 512 may be removable, non-removable, or a combination thereof. In some examples, the memory 512 includes a solid-state memory, hard drives, optical-disc drives, etc. The computing device 500 includes the one or more processors 514 that read data from various entities, such as the bus 510, the memory 512, or the I/O components 520. The one or more presentation component(s) 516 presents data indications to a person or other device. In an example, the one or more presentation component(s) 516 include a display device, a speaker, a printing component, a vibrating component, etc. The I/O port(s) 518 allow the computing device 500 to be logically coupled to other devices, including the I/O components 520, some of which may be built in the computing device 500. The I/O components 520 include a microphone, a joystick, a game pad, a satellite dish, a scanner, a printer, a wireless device, etc.

The radio(s) 524 of the computing device 500 represents a radio that facilitates communication with a wireless telecommunications network. In an example, wireless telecommunications technologies include, but are not limited to, code-division multiple access (CDMA), general packet radio service (GPRS), time-division multiple access (TDMA), global system for mobile communication (GSM), and the like. The radio(s) 524 may additionally or alternatively facilitate other types of wireless communications including wireless fidelity (Wi-Fi), worldwide interoperability for microwave access (WiMAX), long-term evolution (LTE), or other voice over internet protocol (VoIP) communications. As may be appreciated, in various embodiments, the radio(s) 524 may be configured to support multiple technologies and/or multiple radios may be utilized to support multiple technologies. The wireless telecommunications network may include an array of devices, which are not shown so as to not obscure more relevant aspects of the present disclosure. Components, such as the base transceiver station 112, a communications tower, or access points (as well as other components), may provide wireless connectivity in some embodiments.

Many different arrangements of the various components depicted, as well as components not shown, are possible without departing from the scope of the claims below. Embodiments of the present disclosure have been described with an intent to be illustrative rather than be restrictive. Alternative embodiments will become apparent to readers of the present disclosure. Alternative means of implementing the aforementioned aspects may be completed without departing from the scope of the claims below. Certain features and sub-combinations of aspects of the present disclosure are of utility and may be employed without reference to other features and sub-combinations and are contemplated within the scope of the claims.

What is claimed is:

1. One or more non-transitory computer-readable media having computer-executable instructions embodied thereon that, when executed, perform a method comprising:
receiving, from a first location, by way of a wireless communications network, a set of coordinates corresponding to the first location and a request to deliver one or more parts to the first location;
determining, by way of the wireless communications network, one or more delivery vehicles that have stored within each one of the one or more delivery vehicles, the one or more parts;
determining, by way of the wireless communications network, a first delivery vehicle of the one or more delivery vehicles that is closest relative to the first location;
communicating, to the first delivery vehicle by way of the wireless communications network, instructions to deliver the one or more parts requested to the first location; and
receiving, by way of the wireless communications network, an indication that the first delivery vehicle has delivered the one or more parts to the first location.

2. The media of claim 1, wherein the first location is a repair site for a piece of network infrastructure.

3. The media of claim 1, wherein the first location is an upgrade site for a piece of network infrastructure.

4. The media of claim 1, wherein the first location is a construction site for a piece of network infrastructure.

5. The media of claim 1, wherein the first location is a repair site in response to a natural disaster.

6. The media of claim 1, wherein the first location is determined using a global positioning system associated with a user device at the first location.

7. The media of claim 1, wherein the first delivery vehicle is an electrically powered autonomous vehicle.

8. A method for using a mobile drone delivery device, the method comprising:
receiving, from an first location, by way of a wireless communications network, a set of coordinates corresponding to the first location and a request to deliver one or more parts to the first location;
determining, by way of the wireless communications network, one or more autonomous delivery vehicles that have stored within each one of the one or more autonomous delivery vehicles, the one or more parts;
determining, by way of the wireless communications network, a first autonomous delivery vehicle of the one or more autonomous delivery vehicles wherein the first autonomous delivery vehicle is a closest delivery vehicle relative to the first location;
communicating, to the first autonomous delivery vehicle by way of the wireless communications network, instructions to deliver the one or more parts requested to the first location; and
receiving, by way of the wireless communications network, an indication that the first autonomous delivery vehicle has delivered the one or more parts to the first location.

9. The method of claim 8, wherein the method determines the one or more autonomous delivery vehicles that have the one or more parts stored within by querying an inventory which lists what items are stored on each autonomous delivery vehicle within a geographic area.

10. The method of claim 8, wherein the wireless communications network receives, from the first autonomous delivery vehicle, an updated location of the first autonomous delivery vehicle.

11. The method of claim 8, further comprising receiving, by way of the wireless communications network, a second indication that the one or more parts have been removed from the first autonomous delivery vehicle.

12. The method of claim 8, wherein the first location is a repair site in response to a natural disaster.

13. The method of claim 8, wherein the first location is determined using a global positioning system associated with a user device at the first location.

14. The method of claim 8, wherein the first autonomous delivery vehicle is an electrically powered autonomous vehicle.

15. A system for using a mobile drone delivery device, the system comprising:
one or more processors; and
one or more computer storage hardware devices storing computer-usable instructions that, when used by the one or more processors, cause the one or more processors to:
receive, from an first location, by way of a wireless communications network, a set of coordinates corresponding to the first location and a request to deliver one or more parts to the first location;
determine, by way of the wireless communications network, one or more delivery vehicles that have stored within each one of the one or more delivery vehicles, the one or more parts;
determine, by way of the wireless communications network, a first delivery vehicle of the one or more delivery vehicles wherein the first delivery vehicle is a closest delivery vehicle relative to the first location;
communicate, to the first delivery vehicle by way of the wireless communications network, instructions to deliver the one or more parts requested to the first location; and
receive, by way of the wireless communications network, an indication that the first delivery vehicle has delivered the one or more parts to the first location.

16. The system of claim 15, wherein the wireless communications network receives, from the first delivery vehicle, an updated location of the first delivery vehicle.

17. The system of claim 15, further comprising receiving, by way of the wireless communications network, a second indication that the one or more parts have been removed from the first delivery vehicle.

18. The system of claim 15, wherein the first location is a repair site in response to a natural disaster.

19. The system of claim 15, wherein the first location is determined using a global positioning system associated with a user device at the first location.

20. The system of claim 15, wherein the first delivery vehicle is an electrically powered autonomous vehicle.
